(19) United States
(12) Patent Application Publication
(10) Pub. No.: US 2010/0133949 A1
(43) Pub. Date: Jun. 3, 2010

(54) CONDUCTOR BLANK FOR A DRUM COMMUTATOR, A METHOD FOR THE PRODUCTION THEREOF, AND A DRUM COMMUTATOR

(75) Inventor: Marko Vihtelic, Idrija (SI)

Correspondence Address: KATTEN MUCHIN ROSENMAN LLP, 575 MADISON AVENUE, NEW YORK, NY, 10022-2585, US

(73) Assignee: KOLEKTOR GROUP D.O.O., Idrija (SI)

(21) Appl. No.: 11/917,430

(22) PCT Filed: May 26, 2006
(86) PCT No.: PCT/EP2006/005035

§ 371 Date: Dec. 13, 2007

(30) Foreign Application Priority Data
Jun. 28, 2005 (DE) 10 2005 030 454.0

(51) Int. Cl. H01R 39/04; H01R 43/08

(52) U.S. Cl. 310/235; 310/236; 29/597

(57) ABSTRACT

The invention relates to a closed loop conductor blank for a drum commutator (T). The conductor segments are interconnected via bridge sections. One end face of the conductor segments comprises connecting projections (7) as well as inward-facing anchor ties for anchoring said conductor segments in a support element (1). The first anchor ties (9a, 9b), which are produced by the partial splitting of material on the radially inner surface of the strip in the vicinity of the conductor segments (4), form K-shaped pairs of anchor ties. In addition, second anchor ties (10a, 10b) are provided, said ties being C-shaped and arranged substantially on the end face and being produced by the inward deformation of anchoring projections arranged on the edges of the strip.

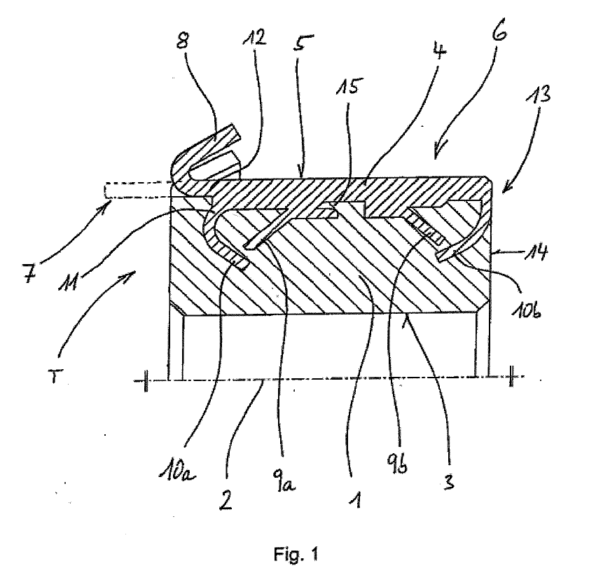

The present invention relates to an annularly closed conductor blank for a drum commutator, with conductor segments that are joined to one another via bridging parts, wherein the conductor segments are provided with terminal projections disposed on one end face and with inwardly directed anchor ties intended for anchoring the conductor segments in a support member. Furthermore, the present invention relates to a method for producing an annularly closed conductor blank for a drum commutator, which blank is provided with conductor segments joined to one another via bridging parts, as well as to a drum commutator produced using the aforesaid conductor blank.

Depending on how they are produced, drum commutators are divided into two groups. In a first design (see, for example, DE 1956340, DE 2140855, U.S. Pat. No. 4,598,463 A, EP 0247221 A1, EP 0243640 B1, DE 29609538 U1, DE 10244006 A1), individual laminations that in particular can be stamped out of profile strip are processed. During manufacture of the commutator, the individual laminations are inserted into a mounting cage, which defines the exact location of the laminations during production of the support member in which the laminations are anchored. Drum commutators produced in this design meet very stringent quality requirements, but are relatively expensive to produce, and so in general they are used only in particularly high-performance electrical products. In a second design, a conductor blank produced from a metal strip by rolling and comprising conductor segments joined to one another via bridging parts is processed. The support member is injection-molded onto the corresponding annular conductor blank. After the support member has been cured, the bridging parts are removed and in this way the conductor segments are separated from one another. Drum commutators according to this design are the subject matter of, for example, U.S. Pat. No. 4,705,977 A, U.S. Pat. No. 3,492,519 A, FR 2458156 A3, U.S. Pat. No. 4,872,255 A, GB 1561460, EP 0019472 A2, DE 1955122, U.S. Pat. No. 4,920,633 A, DE 4138829 A1, DE 3307312 A1, EP 0007186 A1, DE 10233712 B3, DE 10306516 A1, DE 2328698, EP 0780029 and WO 01/61796 A1. Compared with the first design mentioned, such drum commutators have much lower production costs. On the other hand, the drum commutators produced in this way have heretofore met only moderate quality requirements.

Against the background of the prior art outlined in the foregoing, the object of the present invention is to provide a possibility of producing drum commutators according to the second design mentioned, which commutators are characterized by quality features that meet stringent requirements despite low production costs.

To achieve this object, the present invention focuses on the styling of the conductor blank, especially on the styling features that are definitively responsible for anchoring the conductor segments in the support member. According to the present invention, the object specified in the foregoing can be achieved in particular by providing, in an annularly closed conductor blank of the type mentioned hereinabove, first anchor ties forming K-shaped anchor-tie pairs and created by splitting material on the radially inward surface of the strip in the region of the conductor segments, and C-shaped second anchor ties disposed substantially at the end faces and created by inwardly directed bending back of anchoring projections disposed along the rim of the strip. Because of the characteristic combination of different, specifically shaped and disposed anchor ties provided according to the present invention, there can be surprisingly achieved such good anchoring of the conductor segments in the support member that drum commutators produced inexpensively using an annularly closed conductor blank also meet quality requirements that heretofore were achieved only with complex and expensive drum commutators according to the individual lamination design. For this purpose the invention utilizes the knowledge that the deepest possible anchoring of the conductor segments in the support member is advantageous for the dimensional stability of the commutator, even under high loads. Such deep anchoring of the conductor segments in the support member by correspondingly long first anchor ties of the K-shaped anchor-tie pairs can be achieved, while implementing the present invention, by providing, in addition to that K-shaped anchor-tie pair, C-shaped second anchor ties disposed substantially at the end faces and created by inwardly directed bending back of anchoring projections disposed along the rim of the strip. It is only by this end-face anchoring of the conductor segments by means of the C-shaped second anchor ties that it is possible at all to make the first anchor ties sufficiently long that deep anchoring of the conductor segments in the support member is possible therewith. This is so because, with increasing length of the first anchor ties, their root points become increasingly distant from the ends of the conductor segments, and so, according to the prior art, the length of the first anchor ties was limited to such a size that only relatively shallow anchoring of the conductor segments in the support member was possible if deformation of the conductor segments was to be prevented effectively. The second anchor ties provided according to the invention can also be made correspondingly long for deep, secure anchoring of the conductor segments in the support member. As a result, and as explained, it is possible, using inventive conductor blanks, to produce drum commutators that meet very stringent quality requirements even under high loads.

The first anchor ties are generally machined out of rib-like raised projections on the inside surface of the strip. The corresponding rib-like profiling of the strip can be achieved in various ways known in themselves.

Specifically, in the case of relatively small drum commutators, a preferred improvement of the inventive conductor blank is characterized in that the radial distance of the free ends of at least one of the respective first anchor ties of each K-shaped anchor-tie pair from the axis is at most 65% of the radial distance of the radial outside face of the conductor segments from the axis, which face—if necessary with allowance for mechanical post-machining—defines the brush running surface of the drum commutator.

Particularly preferably, the corresponding distance is less than 50%. For the second, C-shaped anchor ties also, the radial distance of the free ends from the axis is preferably at most 65% and particularly preferably less than 50% of the radial distance of the radial outside face of the conductor segments from the axis.

According to another preferred improvement of the invention, the free ends of the second anchor ties in the inventive conductor blank have a smaller distance to the axis of the conductor blank than do the first anchor ties. Particularly preferably, each of the second anchor ties then ends substantially inward of the adjacent first anchor ties in radial direction. Under certain prerequisites, however, it may also be favorable if the free ends of the first anchor ties have a shorter distance to the axis of the conductor blank than do the second anchor ties, in which case each of the second anchor ties can end substantially outward of an adjacent first anchor tie in radial direction.

For typical applications of drum commutators that embody the present invention, it is favorable if C-shaped second anchor ties are provided in the region of both end faces of the conductor blank. In this case, the advantages explained in the foregoing are particularly marked. Ideally, however, the first and second anchor ties adjacent to the terminal projections then end somewhat further inward, in radial direction, than do the first and second anchor ties provided distant from the terminal projections and thus project somewhat more deeply into the support member in corresponding drum commutators. This results in optimal anchoring of the conductor segments with minimal use of material. If a certain loss of quality is tolerated, however, one of each two second anchor ties may also be omitted, so that second anchor ties are provided only in the region of one end face of the conductor blank. From the viewpoint of costs, it is then most favorable to dispense with second anchor ties at the end face of the conductor blank opposite the terminal projections, since in this case the strip material used for production of the conductor blank can be made narrower. Nevertheless, for drum commutators having a large number of conductor segments, it is recommended that the second anchor ties be dispensed with on that side on which the terminal projections are disposed, especially if relatively small commutator diameters are to be achieved.

Another preferred improvement of the invention is characterized in that there are provided, at the end face having the terminal projections, second anchor ties whose root portions are offset radially inward relative to the root portions of the terminal projections. It is not merely in regard to secure anchoring of the conductor segments in the support member of the drum commutator that this is favorable. To the contrary, such a radial offset of the second anchor ties relative to the terminal projections is also advantageous with regard to a brush running surface that is ideally cylindrical as possible, since the inwardly directed bending-back of the anchoring projections along the rim in order to form the C-shaped second anchor ties at the end faces after rolling of the strip does not lead in this case to noteworthy deformation of the conductor segments at their outer surface defining the brush running surface. The foregoing viewpoints can be achieved, for example, if two second anchor ties disposed in pairs on both sides of the respective terminal projection and offset relative thereto in circumferential direction are provided on each conductor segment in the region of the end face provided with the terminal projections. Nevertheless, a particularly preferred improvement is characterized in that precisely one second anchor tie disposed radially inward under the respective terminal projection is provided on each conductor segment in the region of the end face provided with the terminal projections. The corresponding anchoring projection can be formed in particular by splitting a common projection that is also used to form the terminal projections, so that common projections are first provided on the one end edge of the strip, and are then split to produce the terminal projections and also the anchoring projections adjacent thereto, which can be deformed in the same operational step to obtain the inwardly bent second anchoring ties. Such a design is favorable in particular for relatively small-dimension commutators with a large number of commutator segments.

According to yet another preferred improvement of the invention, the conductor segments are provided, between the first anchor ties associated with one another in pairs, with an undercut groove extending in circumferential direction. Such an undercut groove can contribute, via additional anchoring of the conductor segments between the two first anchor ties of each K-shaped anchor-tie pair, to further reduction of the danger of deformation of the conductor segments and thus to improved dimensional stability of the drum commutator, even at high speeds.

Corresponding to the foregoing explanations, and according to the present invention, a method for producing an annularly closed conductor blank for a drum commutator, which blank is provided with conductor segments joined to one another via bridging parts, comprises the following steps:
providing a plane, pre-profiled metal strip with terminal projections disposed along the rim and anchoring projections also disposed along the rim;
rolling the strip;
creating first anchor ties, which respectively form a K-shaped anchor-tie pair, by splitting material on the radially inward surface of the strip in the region of the conductor segments;
inwardly directed bending back of the anchoring projections along the rim in order to form C-shaped second anchor ties substantially at the end faces.

The special advantages of this method can be derived directly from the foregoing explanations of the conductor blank according to the present invention. Preferably the said strip will be rolled before the first anchor ties are formed; this is favorable with regard to the smallest possible manufacturing expense.

However, this is not imperative; another option, provided suitable machines and tools are used for the purpose, is to roll the strip only after formation of the first anchor ties. Further preferred improvements of the inventive method can be derived directly from the foregoing explanations on the conductor blank according to the present invention.

During application of the present invention, drum commutators having a support member made of insulating molding compound and conductor segments anchored therein are produced by first injection molding—in a manner known in itself—a support member onto an inventive conductor blank explained hereinabove and, after injection molding of the support member, removing the bridging parts that at first join the conductor segments to one another. It is particularly advantageous if second anchor ties disposed at the end face opposite the terminal projections end substantially flush with the end face of the support member at their root end. As regards the importance, explained hereinabove, of deep anchoring of the conductor segments in the support member, other preferred improvements of the inventive drum commutator are characterized in that the radial extent of at least one first anchor tie of each K-shaped anchor-tie pair and/or of the second anchor ties is at least 40% of the distance of the root of the anchor tie in question from the shaft bore of the support member.

The present invention will be explained in more detail hereinafter on the basis of a preferred exemplary embodiment illustrated in the drawing. This drawing shows, in a (half) axial section, a drum commutator produced using an inventive conductor blank.

Drum commutator T illustrated in the drawing comprises a support member 1 formed from insulating molding compound with a shaft bore 3 disposed concentrically with axis 2 as well as a plurality of conductor segments 4 anchored in the support member. Cylindrical outside face 5 of conductor segments 4 represents brush running surface 6. The individual conductor segments are obtained in a manner known in itself from an annular conductor blank produced from a strip, in which blank the conductor segments are joined to one another via bridging parts, which are removed after injection molding of support member 1.

In the annularly closed conductor blank used for production of the illustrated drum commutator, each conductor segment 4 is provided with a terminal projection 7 disposed on one end face, from which projection a terminal hook 8 for the rotor winding is formed by subsequent bending back, and anchor ties directed inwardly toward axis 2 and designed for anchoring the conductor segments in support member 1, namely two first anchor ties 9a, 9b and two second anchor ties 10a, 10b disposed substantially at the end faces. The two first anchor ties 9a, 9b, which form a K-shaped anchor-tie pair, are created by splitting material on the radially inward surface of the strip in the region of conductor segments 4; in contrast, the two second anchor ties 10a, 10b, which are substantially C-shaped, are created by inwardly directed bending back of anchoring projections disposed along the rim of the strip. In the region of the end face provided with the respective terminal projection 7, a second anchor tie 10a is provided on each conductor segment 4, specifically in such a way that the root portion 11 of second anchor tie 10a is offset radially inward relative to root portion 12 of terminal projection 7.

The free ends of second anchor ties 10a and 10b each have a smaller distance to axis 2 of the conductor blank than do the ends of the associated first anchor ties 9a and 9b. This second anchor tie 10a disposed in the region of the end face provided with terminal projections 7 ends radially inward of associated first anchor tie 9a; and second anchor tie 10b disposed in the region of opposite end face 13 ends radially inward of associated second anchor tie 9b. Second anchor tie 10b disposed on end face 13 of the conductor segment opposite terminal projection 7 ends substantially flush at its root end with end face 14 of support member 1.

First anchor tie 9a and second anchor tie 10a adjacent to terminal projections 7 end slightly further inward in radial direction than do first and second anchor ties 9b and 10b, which are provided distant from the terminal projections. The radial distance of the free end of first anchor tie 9a at the terminal end from axis 2 is 65% and the radial distance of the free end of associated second anchor tie 10a from axis 2 is 55% of the radial distance of radial outside face 5 of the conductor segment from axis 2.

Each conductor segment 4 is provided between first anchor ties 9a and 9b associated with one another in pairs with an undercut groove 15, which extends in circumferential direction and is filled with molding compound.

1. An annularly closed conductor blank for a drum commutator (T), with conductor segments (4) that are joined to one another via bridging parts, wherein the conductor segments are provided with terminal projections (7) disposed on one end face and with inwardly directed anchor ties intended for anchoring the conductor segments in a support member (1), characterized in that
there are provided first anchor ties (9a, 9b) forming K-shaped anchor-tie pairs and created by splitting material on the radially inward surface of the strip in the region of the conductor segments (4), and C-shaped second anchor ties (10a, 10b) disposed substantially at the end faces and created by inwardly directed bending back of anchoring projections disposed along the rim of the strip.

2. A conductor blank according to claim 1,
characterized in that
the radial distance of the free ends of at least one of the respective first anchor ties (9a, 9b) from the axis (2) is at most 65% of the radial distance of the radial outside face (5) of the conductor segments (4) from the axis.

3. A conductor blank according to claim 1,
characterized in that
the radial distance of the free ends of the second anchor ties (10a, 10b) from the axis (2) is at most 65% of the radial distance of the radial outside face (5) of the conductor segments (4) from the axis (2).

4. A conductor blank according to claim 1,
characterized in that
the free ends of the second anchor ties (10a, 10b) have a smaller distance to the axis (2) of the conductor blank than do the first anchor ties (9a, 9b).

5. A conductor blank according to claim 4,
characterized in that
each of the second anchor ties (10a, 10b) ends substantially inward of the adjacent first anchor ties (9a, 9b) in radial direction.

6. A conductor blank according to claim 1,
characterized in that
the free ends of the first anchor ties (9a, 9b) have a shorter distance to the axis (2) of the conductor blank than do the second anchor ties (10a, 10b).

7. A conductor blank according to claim 6,
characterized in that
each of the second anchor ties (10a, 10b) ends substantially outward of an adjacent first anchor tie (9a, 9b) in radial direction.

8. A conductor blank according to claim 1,
characterized in that
second anchor ties (10a, 10b) are provided in the region of both end faces.

9. A conductor blank according to claim 8,
characterized in that
the first and second anchor ties (9a, 10a) adjacent to the terminal projections (7) end further inward, in radial direction, than do the first and second anchor ties (9b, 10b) provided distant from the terminal projections.

10. A conductor blank according to claim 1,
characterized in that
second anchor ties (10a, 10b) are provided only in the region of one end face of the conductor blank.

11. A conductor blank according to claim 1,
characterized in that
there are provided, at the end face having the terminal projections (7), second anchor ties (10a) whose root portions (11) are offset radially inward relative to the root portions (12) of the terminal projections.

12. A conductor blank according to claim 11,
characterized in that
precisely one second anchor tie (10a) disposed radially inward under the respective terminal projection is provided on each conductor segment (4) in the region of the end face provided with the terminal projections (7).

13. A conductor blank according to claim 1,
characterized in that
the conductor segments (4) are provided, between the first anchor ties (9a, 9b) associated with one another in pairs, with an undercut groove (15) extending in circumferential direction.

14. A method for producing an annularly closed conductor blank for a drum commutator (T), which blank is provided with conductor segments (4) joined to one another via bridging parts, comprising the following steps:
providing a plane, pre-profiled metal strip with terminal projections (7) disposed along the rim and anchoring projections also disposed along the rim;
rolling the strip;
creating first anchor ties (9a, 9b), which respectively form a K-shaped anchor-tie pair, by splitting material on the radially inward surface of the strip in the region of the conductor segments;
inwardly directed bending back of the anchoring projections along the rim in order to form C-shaped second anchor ties (10a, 10b) substantially at the end faces.

15. A method according to claim 14
characterized in that
the strip is rolled before the first anchor ties (9a, 9b) are formed.

16. A drum commutator (T) having a support member (1) made of insulating molding compound and conductor segments (4) anchored therein, which are produced from a conductor blank according to claim 1 by removing the bridging parts after injection molding of the support member.

17. A drum commutator according to claim 16,
characterized in that second anchor ties (10b) disposed at the end face (13) opposite the terminal projections (7) end substantially flush with the end face (14) of the support member (1) at their root end.

18. A drum commutator according to claim 16,
characterized in that
the radial extent of at least one first anchor tie (9a, 9b) of each K-shaped anchor-tie pair is at least 40% of the distance of the root of the anchor tie in question from the shaft bore (3) of the support member (1).

19. A drum commutator according to claim 16,
characterized in that
the radial extent of the second anchor ties (10a, 10b) is at least 40% of the distance of the root of the anchor tie in question from the shaft bore (3) of the support member (1).
